(19) United States
(12) Patent Application Publication
(10) Pub. No.: US 2022/0255260 A1
(43) Pub. Date: Aug. 11, 2022

(54) CONNECTOR

(71) Applicant: SUMITOMO WIRING SYSTEMS, LTD., Mie (JP)

(72) Inventor: Yasuhiro KUDO, Mie (JP)

(21) Appl. No.: 17/622,255

(22) PCT Filed: Jun. 8, 2020
(86) PCT No.: PCT/JP2020/022463

§ 371 Date: Dec. 23, 2021

(30) Foreign Application Priority Data
Jun. 28, 2019 (JP) 2019-121527

(51) Int. Cl. H01R 13/52; H01R 13/506; H01R 13/6581

(52) U.S. Cl. CPC H01R 13/5205; H01R 2201/26; H01R 13/6581; H01R 13/506

(57) ABSTRACT

It is aimed to provide a connector capable of suppressing the separation of a retainer from a housing. A connector 10 is provided with a housing 20 including a plurality of tubular inserting portions 21 arranged in parallel to each other, a plurality of wires 100 being individually inserted into the inserting portions, sealing members 30 for sealing between the wires 100 and the inserting portions 21, and a retainer 40 to be locked to the housing 20, the retainer 40 retaining the sealing members 30. Recessed portions 25 are provided between two inserting portions 21 adjacent to each other on an outer peripheral surface of the housing 20. The retainer 40 includes locking portions 43 to be locked to the recessed portions 25 by concavo-convex engagement.

### TECHNICAL FIELD

The present disclosure relates to a connector.

### BACKGROUND

Conventionally, a connector is known which includes a housing having a plurality of inserting portions, into which a plurality of wires are individually inserted, sealing members for sealing between each wire and each inserting portion, and a retainer to be locked to the housing, the retainer retaining the sealing members (see, for example, Patent Document 1.

Locking projections are formed on the outer peripheral surface of the retainer described in Patent Document 1. Further, locking recesses to be locked to the locking projections are formed in the inner peripheral surfaces of the respective inserting portions of the housing. By locking the locking projections and the locking recesses to each other, the retainer is locked to the housing. Note that each wire is inserted through each sealing member and the retainer.

### PRIOR ART DOCUMENT

### Patent Document

Patent Document 1: JP 2015-122267 A

### SUMMARY OF THE INVENTION

### Problems to be Solved

In the connector described in Patent Document 1, the inserting portions may be deformed and expanded via the retainer by the application of an external force to the wires. If such expansion of the inserting portions occurs near the locking recesses, the retainer may be separated from the housing due to the disengagement of the locking recesses from the locking projections.

An object of the present disclosure is to provide a connector capable of suppressing the separation of a retainer from a housing.

### Means to Solve the Problem

A connector for achieving the above object is provided with a housing including a plurality of tubular inserting portions arranged in parallel to each other, a plurality of wires being individually inserted into the inserting portions, sealing members for sealing between the wires and the inserting portions, and a retainer to be locked to the housing, the retainer retaining the sealing members, wherein a recessed portion is provided between two inserting portions adjacent to each other on an outer peripheral surface of the housing, and the retainer includes a locking portion to be locked to the recessed portion by concavo-convex engagement.

### Effect of the Invention

According to the present disclosure, the separation of a retainer from a housing can be suppressed.

### BRIEF DESCRIPTION OF THE DRAWINGS

FIG. 1 is an exploded perspective view showing a connector and wires in one embodiment of the connector.

FIG. 2 is a perspective view showing the connector of the embodiment.

FIG. 3 is a perspective view showing a housing of the embodiment.

FIG. 4 is a front view showing the housing of the embodiment.

FIG. 5 is a back view showing the housing of the embodiment viewed from a base end side.

FIG. 6 is a perspective view showing a retainer of the embodiment.

FIG. 7 is a front view showing the retainer of the embodiment.

FIG. 8 is a front view showing the connector of the embodiment.

FIG. 9 is a section along 9-9 of FIG. 8.

FIG. 10 is a section along 10-10 of FIG. 8.

FIG. 11 is a back view showing the connector of the embodiment viewed from the base end side.

### DETAILED DESCRIPTION TO EXECUTE THE INVENTION

### Description of Embodiments of Present Disclosure

First, embodiments of the present disclosure are listed and described.

[1] The connector of the present disclosure is provided with a housing including a plurality of tubular inserting portions arranged in parallel to each other, a plurality of wires being individually inserted into the inserting portions, sealing members for sealing between the wires and the inserting portions, and a retainer to be locked to the housing, the retainer retaining the sealing members, wherein a recessed portion is provided between two inserting portions adjacent to each other on an outer peripheral surface of the housing, and the retainer includes a locking portion to be locked to the recessed portion by concavo-convex engagement.

According to this configuration, the retainer is locked to the housing by locking the locking portion of the retainer to the recessed portion on the outer peripheral surface of the housing by the concave-convex engagement. Thus, even if the inserting portions are expanded due to the application of an external force to the wires, the separation of the retainer from the housing can be suppressed.

Further, since the recessed portion is provided between the two inserting portions adjacent to each other, it can be suppressed that the retainer projects more toward an outer peripheral side than the housing by providing the retainer with the locking portion. In this way, an increase in the size of the connector can be suppressed.

[2] Preferably, when a direction orthogonal to both an arrangement direction of the two inserting portions adjacent to each other and an axial direction of the inserting portions is an orthogonal direction, a pair of the recessed portions are provided on both sides in the orthogonal direction on the outer peripheral surface of the housing, and the retainer includes a pair of the locking portions to be respectively locked to the recessed portions.

According to this configuration, since the pair of locking portions are locked to the pair of recessed portions, the separation of the retainer from the housing can be further suppressed.

[3] Preferably, when a direction orthogonal to both an arrangement direction of the two inserting portions adjacent to each other and an axial direction of the inserting portions is an orthogonal direction, the retainer includes a protecting portion provided adjacent to the locking portion and located more outward in the orthogonal direction than the locking portion.

According to this configuration, for example, if a component arranged around the connector is about to contact the locking portion of the retainer or the retainer falls down and the locking portion is about to contact a floor surface, the protecting portion located more on the outer peripheral side than the locking portion contacts the component, the floor surface or the like. In this way, the deformation of the locking portion can be suppressed.

[4] Preferably, when a direction orthogonal to both an arrangement direction of the two inserting portions adjacent to each other and an axial direction of the inserting portions is an orthogonal direction, the locking portion is entirely located inwardly of outermost parts in the orthogonal direction of outer peripheral surfaces of the inserting portions.

According to this configuration, it can be avoided that the retainer projects more toward the outer peripheral side than the housing by providing the retainer with the locking portion. In this way, an increase in the size of the connector can be even more suppressed.

[5] Preferably, the recessed portion is formed with a projection projecting toward an outer peripheral side, and the locking portion is formed with a recess to be locked to the projection.

According to this configuration, since the recess formed in the locking portion is locked to the projection formed on a separation wall portion, a mutually engaged state of the projection and the recess can be easily visually confirmed. Therefore, an engaging operation of the retainer with the housing can be easily performed.

[6] Preferably, a shield member is provided which covers the housing, and the shield member is provided with a restricting portion for restricting separation of the retainer from the housing by being located on a side opposite to the sealing members with respect to the retainer.

According to this configuration, the separation of the retainer from the housing can be even more suppressed by the restricting portion.

Further, since the restricting portion is provided as a part of the shield member, an increase in the number of components of the connector caused by providing the restricting portion can be suppressed.

### Details Of Embodiment of Present Disclosure

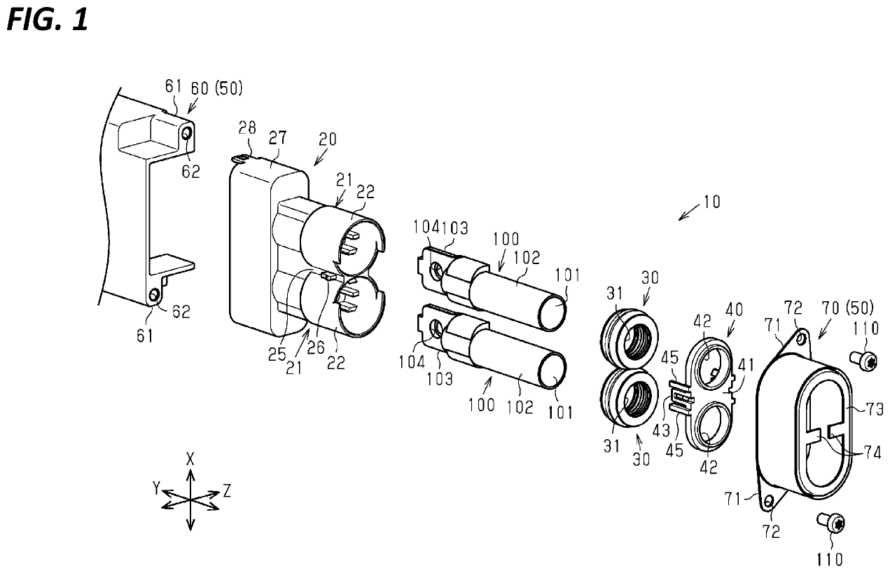

Hereinafter, one embodiment of a connector is described with reference to FIGS. 1 to 11. Note that the present disclosure is not limited to these illustrations and is intended to be represented by claims and include all changes in the scope of claims and in the meaning and scope of equivalents.

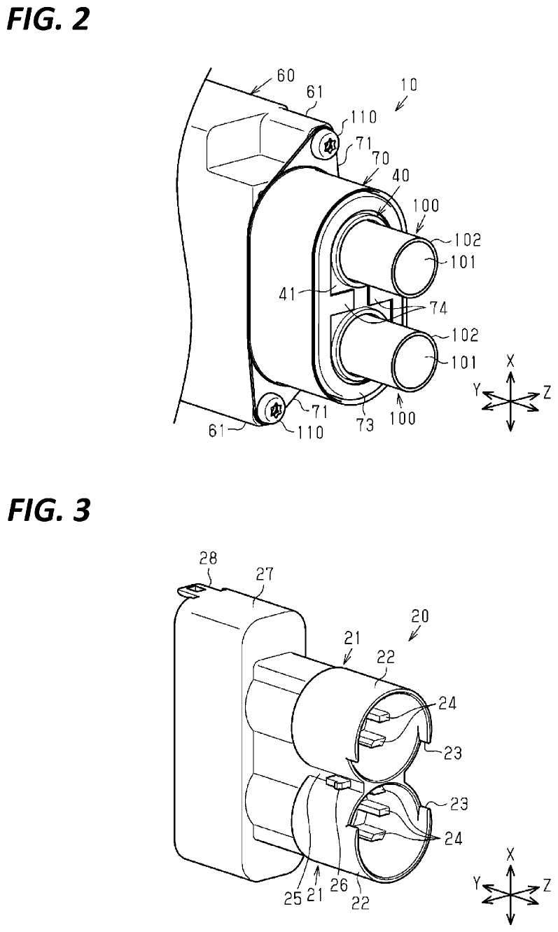

As shown in FIGS. 1 and 2, a connector 10 of this embodiment is for connecting two wires 100 extending in parallel to each other to a device (not shown). Note that examples of the device include a motor and an inverter installed in a hybrid or electric vehicle or the like.

The connector 10 includes a housing 20 made of resin and having two tubular inserting portions 21, which are arranged in parallel to each other and through which the two wires 100 are individually inserted, two sealing members 30 for sealing between each wire 100 and each inserting portion 21, and a retainer 40 for retaining each sealing member 30. The retainer 40 is locked to the housing 20.

The housing 20 is covered by a shield member 50 composed of a shield shell 60 and a bracket 70 fixed to the shield shell 60. By covering the housing 20 by the shield member 50, a part of each wire 100 accommodated in the housing 20 is electromagnetically shielded.

Note that, in the following description, an arrangement direction of the respective inserting portions 21 is referred to as an arrangement direction X, an axial direction of the respective inserting portions 21 is referred to as an axial direction Y, and a direction orthogonal to both the arrangement direction X and the axial direction Y is referred to as an orthogonal direction Z. Further, in the axial direction Y, a side toward which each wire 100 of the connector 10 is pulled out is referred to as a base end side and a side opposite to the base end side is referred to as a tip side.

Each wire 100 includes a conductive core 101 and an insulation coating 102 made of resin for covering the outer periphery of the core 101. A terminal 103 is crimped to the tip of the core 101 exposed from each insulation coating 102. The terminal 103 is formed with an insertion hole 104 into which a bolt (not shown) is inserted.

Next, the configuration of the connector 10 is described in detail.

### Housing 20

As shown in FIG. 3, the housing 20 includes an accommodating portion 27 which communicates with tip sides of the respective inserting portions 21 and into which the terminals 103 of the respective wires 100 are accommodated. The accommodating portion 27 is open toward the tip side and has a rectangular tube shape long in the arrangement direction X.

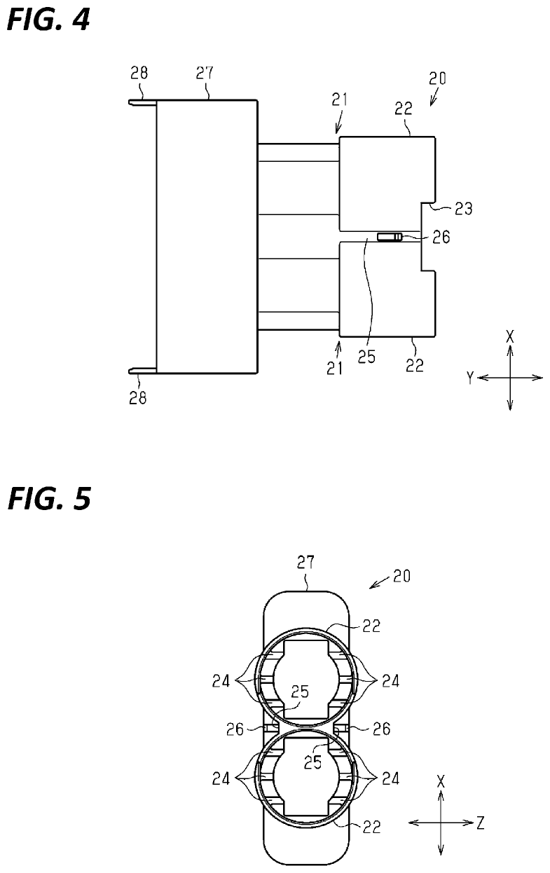

As shown in FIG. 4, a pair of locking portions 28 projecting toward the tip side are provided on both sides in the arrangement direction X of an edge part on the tip side of the accommodating portion 27. Although not shown, the respective locking portions 28 are covered by the shield shell 60 and locked to a constituent component constituting the connector 10.

As shown in FIGS. 3 to 5, a base end portion 22 constituting a part on the base end side of each inserting portion 21 has a substantially hollow cylindrical shape. Note that the outer peripheral surface of the base end portion 22 is located more on an outer peripheral side than other parts of the inserting portion 21.

In parts of the base ends of the respective base end portions 22 facing each other, cut portions 23 are formed by cutting parts of these base ends. As shown in FIGS. 3 and 5, a plurality of ribs 24 extending along the axial direction Y are provided on the inner peripheral surface of each base end portion 22 while being spaced apart from each other in a circumferential direction of the base end portion 22. In this embodiment, six ribs 24 are provided in each base end portion 22. Note that the base end surfaces of the respective ribs 24 are located on the same plane orthogonal to the axial direction Y.

Recessed portions 25 are provided between the two inserting portions 21 adjacent to each other on the outer peripheral surface of the housing 20. The recessed portions 25 are provided on both sides in the orthogonal direction Z of the housing 20. Each recessed portion 25 has a flat surface along both the arrangement direction X and the axial direction Y. A projection 26 projecting toward the outer peripheral side of the housing 20, i.e. outward in the orthogonal direction Z, is formed on each recessed portion 25, i.e. between two adjacent base end portions 22.

As shown in FIG. 5, each projection 26 is located inwardly of an outermost part in the orthogonal direction Z of the outer peripheral surface of each base end portion 22.

### Sealing Member 30

As shown in FIG. 1, the sealing member 30 is formed of a resin material and has a ring shape. The sealing member 30 is formed with an insertion hole 31 through which the wire 100 is inserted. The sealing member 30 is accommodated into the base end portion 22 of the housing 20 from the base end side and held in contact with the base end surfaces of the ribs 24. In this way, a movement of the sealing member 30 to the tip side is restricted.

### Retainer 40

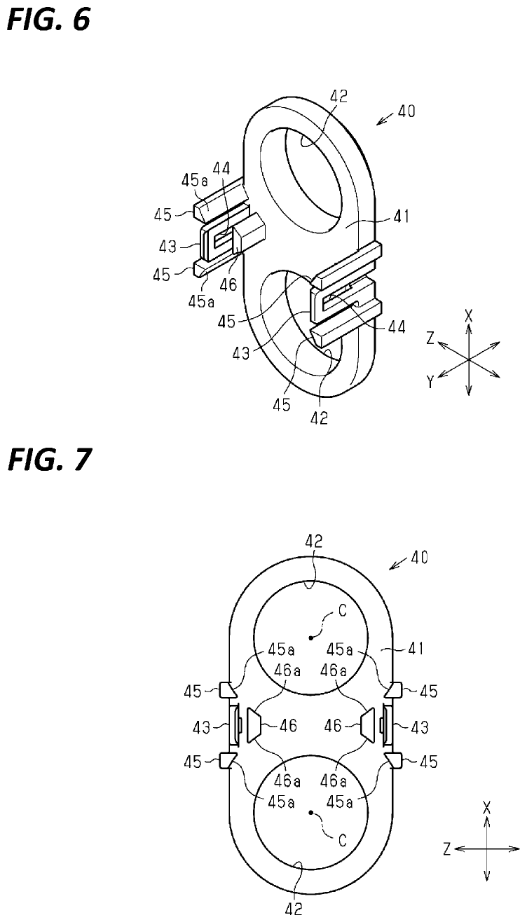

As shown in FIGS. 6 and 7, the retainer 40 includes a body portion 41 to be accommodated into the respective base end portions 22 of the housing 20 from the base end side and configured to collectively cover the respective sealing members 30, and a pair of locking portions 43 extending toward the tip side from both sides in the orthogonal direction Z of the body portion 41. The retainer 40 is formed of a resin material.

The body portion 41 is in the form of an oval plate long in the arrangement direction X. The body portion 41 is formed with two insertion holes 42, through which the respective wires 100 are inserted and which are spaced apart from each other in the arrangement direction X.

Each locking portion 43 is formed with a recess 44 to be locked to the projection 26 of the housing 20. Each recess 44 penetrates through the locking portion 43 in the orthogonal direction Z and extends along the axial direction Y.

Protecting portions 45 located more on the outer peripheral side, i.e. located more outward in the orthogonal direction Z, than the locking portion 43 are provided adjacent to each other on both sides in the arrangement direction X of each locking portion 43. Each protecting portion 45 extends from the body portion 41 toward the tip side. A projection amount of each protecting portion 45 is substantially equal to that of each locking portion 43.

As shown in FIG. 7, a facing surface 45a of each protecting portion 45 facing the outer peripheral surface of the base end portion 22 of the housing 20 has an arc shape centered on an axis C of the inserting portion 42.

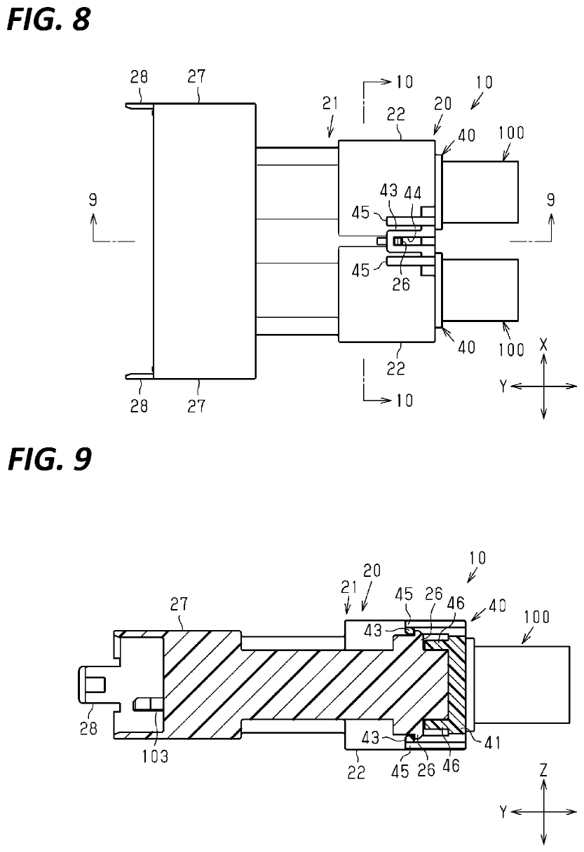

As shown in FIGS. 8 and 9, each recess 44 of the locking portion 43 is locked to each projection 26 of the housing 20 by concavo-convex engagement. More particularly, the inner surface on the base end side of each recess 44 and the outer surface on the tip side of each projection 26 are locked. In this way, a movement of the retainer 40 to the base end side is restricted.

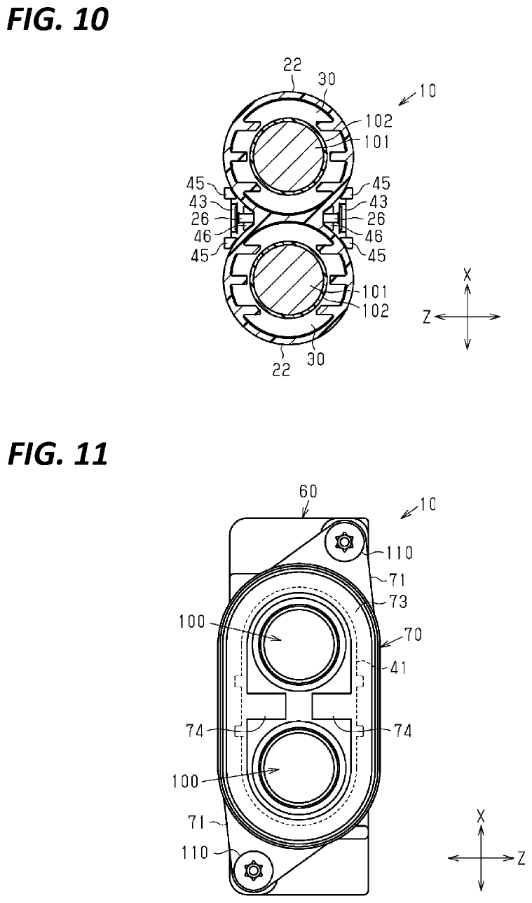

As shown in FIGS. 9 and 10, with the retainer 40 locked to the housing 20, the respective locking portions 43 are entirely located inwardly of the outermost parts in the orthogonal direction Z of the outer peripheral surfaces of the base end portions 22 of the respective inserting portions 21. Further, the respective protecting portions 45 are substantially flush with the outermost parts in the orthogonal direction Z of the outer peripheral surfaces of the base end portions 22 of the respective inserting portions 21.

At this time, as shown in FIG. 10, the facing surfaces 45a (see FIG. 7) of the respective protecting portions 45 are along the outer peripheral surfaces of the respective base end portions 22.

As shown in FIGS. 6 and 7, a pair of protuberances 46 projecting toward the tip side are formed in parts inward of the respective locking portions 43 in the orthogonal direction Z on the outer surface on the tip side of the body portion 41. A projection amount of the protuberances 46 is smaller than that of the locking portions 43.

As shown in FIG. 7, a facing surface 46a of each protuberance 46 facing the outer peripheral surface of the base end portion 22 of the housing 20 has an arc shape centered on the axis C of the inserting portion 42.

As shown in FIG. 9, with the retainer 40 locked to the housing 20, the respective protuberances 46 are facing the respective projections 26 of the housing 20. In this way, a movement of the retainer 40 to the tip side is restricted.

At this time, as shown in FIG. 10, the facing surfaces 46a (see FIG. 7) of the respective protuberances 46 are along the outer peripheral surfaces of the respective base end portions 22.

### Shield Shell 60

As shown in FIGS. 1 and 2, the shield shell 60 covers a part of the housing 20 closer to the tip side than the base end portions 22. Note that a part on the tip side of the shield shell 60 is not shown in FIGS. 1 and 2. The shield shell 60 is formed, for example, by a die cast method using aluminum, aluminum alloy or the like as a material.

A pair of fixing portions 61 are provided on both sides in the arrangement direction X of a part on the base end side of the shield shell 60. A screw hole 62 is formed in the base end surface of each fixing portion 61.

### Bracket 70

As shown in FIGS. 1 and 2, the bracket 70 in the form of an oval tube is mounted on the base end side of the shield shell 60. The bracket 70 is formed, for example, press-working a steel plate or the like.

Flanges 71 projecting toward both sides in the arrangement direction X are provided on an edge part on the tip side of the bracket 70. Each flange 71 is formed with an insertion hole 72, into which a screw 110 is inserted. By inserting the screws 110 into the respective insertion holes 72 and screwing the screws 110 into the screw holes 62 of the respective fixing portions 61 of the shield shell 60, the bracket 70 is fixed to the shield shell 60.

As shown in FIG. 11, a restricting portion 73 protruding toward an inner peripheral side is provided over the entire periphery on an edge part on the base end side of the bracket 70. The restricting portion 73 restricts the separation of the retainer 40 from the housing 20 by being located on a side opposite to the respective shield members 30 with respect to the retainer 40. The restricting portion 73 covers the outer peripheral edge of the body portion 41 of the retainer 40 from the base end side.

The restricting portion 73 is integrally provided with a pair of projecting portions 74 extending from both sides in the orthogonal direction Z toward a clearance between the respective wires 100. The respective projecting portions 74 are located in a part between the respective insertion holes 42 of the body portion 41 on the base end side of the retainer 40. Therefore, the separation of the retainer 40 from the housing 20 is restricted by the projecting portions 74 in addition to the restricting portion 73.

The outer peripheral surface of the bracket 70 is covered by an end of a braided wire (not shown) formed by braiding conductive strands into a tubular shape. The braided wire is fixed to the bracket 70 by a crimp ring (not shown). In this way, the bracket 70 and the braided wire are electrically connected.

Functions and effects of this embodiment are described.

(1) The recessed portions 25 are provided between the two inserting portions 21 adjacent to each other on the outer peripheral surface of the housing 20. The retainer 40 includes the locking portions 43 to be locked to the recessed portions 25 by the concavo-convex engagement.

According to this configuration, the retainer 40 is locked to the housing 20 by locking the locking portions 43 of the retainer 40 to the recessed portions 25 on the outer peripheral surface of the housing 20 by the concavo-convex engagement. Thus, the separation of the retainer 40 from the housing 20 can be suppressed, for example, even if the inserting portions 21 are expanded due to the application of an external force to the wires 100.

Further, since the recessed portions 25 are provided between the two inserting portions 21 adjacent to each other, it can be suppressed that the retainer 40 projects more toward the outer peripheral side than the housing 20 by providing the retainer 40 with the locking portions 43. In this way, an increase in the size of the connector 10 can be suppressed.

(2) The pair of recessed portions 25 are provided on both sides in the orthogonal direction Z on the outer peripheral surface of the housing 20. The retainer 40 includes the pair of locking portions 43 to be locked to the respective recessed portions 25.

According to this configuration, since the pair of locking portions 43 are locked to the pair of recessed portions 25, the separation of the retainer 40 from the housing 20 can be further suppressed.

(3) The retainer 40 includes the protecting portions 45 provided adjacent to the locking portions 43 and located more outward in the orthogonal direction Z than the locking portions 43.

According to this configuration, for example, if a component arranged around the connector 10 is about to contact the locking portions 43 of the retainer 40 or the retainer 40 falls down and the locking portions 43 are about to contact a floor surface, the protecting portions 45 located more outward in the orthogonal direction Z than the locking portions 43 contact the component, the floor surface or the like. In this way, the deformation of the locking portions 43 can be suppressed.

(4) The entire locking portions 43 are located inwardly of the outermost parts in the orthogonal direction Z of the outer peripheral surfaces of the inserting portions 21.

According to this configuration, it can be avoided that the retainer 40 projects more toward the outer peripheral side, i.e. more outward in the orthogonal direction Z, than the housing 20 by providing the retainer 40 with the locking portions 43.

(5) The recessed portions 25 are formed with the projections 26 projecting toward the outer peripheral side, and the locking portions 43 are formed with the recesses 44 to be locked to the projections 26.

According to this configuration, since the recesses 44 formed in the locking portions 43 are locked to the projections 26 formed on the recessed portions 25, a mutually engaged state of the projections 26 and the recesses 44 can be more easily visually confirmed. Therefore, an engaging operation of the retainer 40 with the housing 20 can be easily performed.

An external force applied to the wires 100 is a cause for temporarily deforming the housing 20 (e.g. the base end portions 22 of the inserting portions 21) by being transmitted to the housing 20. However, the recessed portions 25 between the two inserting portions 21 adjacent to each other are parts, which are hardly deformed even if the external force applied to the wires 100 is transmitted to the housing 20. By providing the projections 26 on the recessed portions 25 that are hardly deformed by an external force, the projections 26 and the recesses 44 are unlikely to be disengaged even if the external force applied to the wires 100 is transmitted to the housing 20. Therefore, the projections 26 provided on the recessed portions 25 are suitable to suppress the separation of the retainer 40 from the housing 20.

(6) The bracket 70 of the shield member 50 is provided with the restricting portion 73 for restricting the separation of the retainer 40 from the housing 20 by being located on the side opposite to the sealing members 30 with respect to the retainer 40.

According to this configuration, the separation of the retainer 40 from the housing 20 can be even more suppressed by the restricting portion 73.

Further, since the restricting portion 73 is provided as a part of the bracket 70, an increase in the number of components of the connector 10 caused by providing the restricting portion 73 can be suppressed.

### Modifications

This embodiment can be modified and carried out as follows. The above embodiment and the following modifications can be carried out in combination without technically contradicting each other.
The entire restricting portion 73 of the bracket 70 can be omitted or only the projecting portions 74 of the restricting portion 73 can be omitted.
The number and shape of the projecting portions 74 of the bracket 70 can be changed as appropriate.
The recessed portions 25 of the housing 20 may be formed with recesses and the locking portions 43 of the retainer 40 may be formed with projections to be locked to the recesses.
The locking portions 43 of the retainer 40 only have to be locked to the recessed portions 25 by the concavo-convex engagement and the locking portions 43 may be partially located outwardly of the outermost parts in the orthogonal direction Z of the outer peripheral surfaces of the base end portions 22 of the respective inserting portions 21.
The number and shape of the protecting portions 45 of the retainer 40 can be changed as appropriate.
The protecting portions 45 of the retainer 40 can be omitted.
The retainer 40 may include only one locking portion 43.
The housing 20 may include three or more inserting portions 21 arranged in parallel to each other in the arrangement direction X or a plurality of circularly arranged inserting portions 21. Even in these cases, the retainer 40 only has to include a plurality of locking portions 43 to be respectively locked to a plurality of recessed portions 25 provided between adjacent ones of the inserting portions 21.
The base end portions 22 of the housing 20 may not have a hollow cylindrical shape. Besides, the base end portions 22 may, for example, have a rectangular tube shape.
Although an example of the connector 100 having the facing direction X, the axial direction Y and the orthogonal direction Z orthogonal to each other has been described in the embodiment, “orthogonal” means not only strictly orthogonal, but also substantially orthogonal within a range in which functions and effects in the embodiment are achieved. Further, “parallel” in this embodiment means not only strictly parallel, but also substantially parallel within a range in which functions and effects in the embodiment are achieved.
If the direction orthogonal to both the arrangement direction of the two inserting portions adjacent to each other and the axial direction of the respective inserting portions is the orthogonal direction Z, the projections 26 may be configured not to project in the orthogonal direction Z from the locking portions 43 with the retainer 40 mounted in the housing 20 and the locking portions 43 locked to the projections 26. This configuration is advantageous in combining the suppression of the enlargement of the connector 10 in the orthogonal direction Z and the suppression of the separation of the retainer 40 from the housing 20 as shown in FIGS. 9 and 10.
The recesses 44 of the embodiment may be through holes and the locking portions 28, 43 of the embodiment may be called holed pieces.
The locking portion 43 of the embodiment may be called a looped locking plate including the recess 44 or merely a loop. The projection 26 of this embodiment may be called a clawed projection including a pedestal having a seal surface, on which the looped locking plate (43) is laid, and a claw projecting from the pedestal or a stepped pedestal. For example, with a claw of the projection 26 inserted in the recess 44 of the looped locking plate (43) as shown in FIG. 9, the pedestal (seat surface) of the projection 26 can be held in contact with a plate surface of the looped locking plate (43) and support the looped locking plate (43).

### LIST OF REFERENCE NUMERALS

10 connector

20 housing

21 inserting portion

22 base end portion

23 cut portion

24 rib

25 recessed portion

26 projection

27 accommodating portion

28 locking portion

30 sealing member

31 insertion hole

40 retainer

41 body portion

42 insertion hole

43 locking portion

44 recess

45 protecting portion

45a facing surface

46 protrusion

46a facing surface

50 shield member

60 shield shell

61 fixing portion

62 screw hole

70 bracket

71 flange

72 insertion hole

73 restricting portion

74 projecting portion

100 wire

101 core

102 insulation coating

103 terminal

104 insertion hole

110 screw

C axis

X arrangement direction

Y axial direction

Z orthogonal direction

1. A connector, comprising:
a housing including a plurality of tubular inserting portions arranged in parallel to each other, a plurality of wires being individually inserted into the inserting portions;
sealing members for sealing between the wires and the inserting portions; and
a retainer to be locked to the housing, the retainer retaining the sealing members,
wherein:
a recessed portion is provided between two inserting portions adjacent to each other on an outer peripheral surface of the housing, and
the retainer includes a locking portion to be locked to the recessed portion by concavo-convex engagement.

2. The connector of claim 1, wherein:
when a direction orthogonal to both an arrangement direction of the two inserting portions adjacent to each other and an axial direction of the inserting portions is an orthogonal direction,
a pair of the recessed portions are provided on both sides in the orthogonal direction on the outer peripheral surface of the housing, and
the retainer includes a pair of the locking portions to be respectively locked to the recessed portions.

3. The connector of claim 1, wherein:
when a direction orthogonal to both an arrangement direction of the two inserting portions adjacent to each other and an axial direction of the inserting portions is an orthogonal direction,
the retainer includes a protecting portion provided adjacent to the locking portion and located more outward in the orthogonal direction than the locking portion.

4. The connector of claim 1, wherein:
when a direction orthogonal to both an arrangement direction of the two inserting portions adjacent to each other and an axial direction of the inserting portions is an orthogonal direction,
the locking portion is entirely located inwardly of outermost parts in the orthogonal direction of outer peripheral surfaces of the inserting portions.

5. The connector of claim 1, wherein:
the recessed portion is formed with a projection projecting toward an outer peripheral side, and
the locking portion is formed with a recess to be locked to the projection.

6. The connector of claim 1, comprising a shield member for covering the housing, wherein:
the shield member is provided with a restricting portion for restricting separation of the retainer from the housing by being located on a side opposite to the sealing members with respect to the retainer.
